(19) United States
(12) Patent Application Publication
(10) Pub. No.: US 2025/0381599 A1
(43) Pub. Date: Dec. 18, 2025

(54) ADDITIVE MANUFACTURING APPARATUS AND ADDITIVE MANUFACTURING PROCESS

(71) Applicant: DMG MORI ADDITIVE GmbH, Bielefeld (DE)

(72) Inventors: Marko BÄRTL, Neumarkt (DE); Peter KOPPA, Paderborn (DE); Marc TIMMER, Delbrück (DE)

(21) Appl. No.: 18/877,579

(22) PCT Filed: Nov. 28, 2022
(86) PCT No.: PCT/EP2022/083429

§ 371 Date: Dec. 20, 2024

(30) Foreign Application Priority Data
Aug. 24, 2022 (DE) 10 2022 121 405.2

(51) Int. Cl. B22F 10/28; B22F 12/00; B22F 12/37; B22F 12/45; B22F 12/55; B22F 12/70; B33Y 10/00; B33Y 30/00

(52) U.S. Cl. CPC B22F 10/28; B22F 12/37; B22F 12/38; B22F 12/45; B22F 12/55; B22F 12/70; B33Y 10/00; B33Y 30/00

(57) ABSTRACT

The present invention relates to an apparatus for a manufacturing system for additive manufacturing of articles, in particular for a manufacturing system for selective laser melting. The apparatus comprises a process chamber (1) for providing at least one working space in an area of a build field, and at least one partition wall (2) which divides the process chamber (1) into at least two sub-chambers (1a, b), at least one of the at least two sub-chambers (1a, b) providing the at least one working space. This sub-chamber has at least one powder coater (22, 22a, b) for applying the powdery material (7) to the build field, and at least one optical module (9a, b). At least one gas inlet (4a, b) or at least one gas outlet (24a, b) are arranged in the at least one partition wall (2).

The present invention relates to an apparatus for a manufacturing system for additive manufacturing of articles, in particular for a manufacturing system for selective laser melting. Furthermore, an improved additive manufacturing process is proposed.

The process of additive manufacturing enables the production of articles by building them up layer-by-layer from a powdery material (material powder) by means of optical interaction. The selective laser melting (SLM) process uses metallic material powders in particular, which are preferably remelted layer-by-layer by means of a focused laser beam to form cohesively solidified sections. In this way, machine parts, tools, prostheses, jewellery, etc. can be produced.

An apparatus for the production of shaped bodies according to the principle of selective laser melting is described, for example, in DE 10 2019 200 680 A1. The subject matter of this application is hereby incorporated by reference.

The layer-by-layer build-up of the articles in additive manufacturing processes allows great geometric freedom in their design. In addition, no product-specific tools are necessary for additive manufacturing, which makes it possible to manufacture small numbers of components economically. Therefore, additive processes are often used in the field of rapid prototyping and in small batch production.

However, in order to be able to benefit from the advantages of additive processes in the context of series production with high component quantities, it is desirable to increase the productivity of additive manufacturing systems, especially SLM manufacturing systems.

It is an object of the present invention to provide an apparatus for the layer-by-layer build-up of articles of powdery material by means of optical interaction (apparatus for the additive manufacturing of articles), with which the productivity of an additive manufacturing system, in particular an SLM manufacturing system, can be increased and preferably at the same time the manufacturing quality of the articles to be manufactured can be improved. In addition, it is an object of the invention to provide an improved additive manufacturing process, in particular an SLM manufacturing process, with which both the productivity of the manufacturing plant and preferably the quality of the manufactured articles can be increased.

In order to solve the objects, the features of the independent claims are proposed. Advantageous embodiments can be found in the dependent claims.

An apparatus for layer-by-layer build-up of articles of powdery material by means of optical interaction comprises a process chamber for providing at least one working space in the area of at least one build field. The apparatus may in particular be provided for a selective laser melting process. In this case, metallic materials may preferably be used.

The working space is in particular a space/volume of the process chamber in which the layer-by-layer build-up of one or more articles takes place. A build field is preferably understood to be a two-dimensional area in the working space in which the optical interaction for solidifying the powdery material takes place. In selective laser melting, a build field may thus comprise a two-dimensional area in the working space in which a focused laser beam impinges on a top layer of the powdery material.

Furthermore, the apparatus comprises at least one partition wall which divides the process chamber into at least two sub-chambers, wherein at least one of the at least two sub-chambers provides the at least one working space. Depending on the size of the process chamber and the articles to be manufactured, the process chamber may be divided into two sub-chambers by means of one partition wall, into four sub-chambers by means of two partition walls, into six sub-chambers by means of three partition walls, and so on. Each of the sub-chambers formed in this way may provide at least one working space. Alternatively, only a predetermined number of the sub-chambers formed may provide at least one working space. Preferably, sub-chambers with at least one working space may have substantially the same size (volume). However, it is also possible to form sub-chambers with at least one working space in different sizes.

The at least one sub-chamber providing the at least one working space preferably has at least one powder coater and at least one optical module. This means that all sub-chambers formed by partition walls with at least one working space preferably have at least one powder coater and at least one optical module. In this case, the at least one powder coater serves to apply the powdery material to the build field of the sub-chamber. In other words, the powder coater applies the material powder layer-by-layer to the build field provided in the at least one working space of the sub-chamber.

The at least one optical module, which may be part of an irradiation unit or the irradiation unit itself, is used for spatially selective irradiation of the powdery material provided in the build field. In other words, the optical module selectively irradiates the powdery material provided in the area of the build field of the sub-chamber according to geometry specifications for one or more articles to be manufactured after the coater has applied a new layer of powdery material to the build field. In particular, the optical module may be configured to irradiate the material powder with a focused laser beam in a spatially selective manner, so that the powder is selectively heated to such an extent that it briefly passes completely into the liquid phase and solidifies during solidification. Preferably, the optical module is arranged above the sub-chamber and at a distance from it.

Since preferably all sub-chambers formed by the at least one partition wall with at least one working space have at least one separate powder coater and at least one separate optical module, different articles/different types of articles can be manufactured from different materials in the individual sub-chambers. This can increase the flexibility and productivity of the manufacturing system.

Furthermore, the at least one sub-chamber providing the at least one working space comprises at least one gas inlet and at least one gas outlet for supplying and discharging an inert gas into the sub-chamber. This means that each sub-chamber used for additive manufacturing of articles may have a separate inert gas atmosphere with a separate inert gas flow. On the one hand, the inert gas atmosphere may prevent oxidation of the metallic material, and on the other hand, the inert gas flow may contribute to discharge smoke and melt splashes from the build field that is produced when the optical module irradiates the material. For example, argon and/or helium or nitrogen or neon (or others) may be used as inert gases. By dividing the process chamber into individual sub-chambers with a separate optical module and a separate inert gas flow, the formation of smoke can be reduced, and the discharge of the produced smoke can be improved. This allows to provide constant process conditions in the sub-chambers and, thus, increases the manufacturing quality of the produced articles.

For the supply and discharge of the inert gas into the at least one sub-chamber, which provides the at least one working space, either the at least one gas inlet or the at least one gas outlet is arranged in the at least one partition wall. For example, gas may be removed through the partition wall by extracting the inert gas through the partition wall (upwards). For this purpose, for example, suitable ducts/pipes may be arranged in the partition wall through which the inert gas may be conveyed out of the sub-chambers by means of one or more suction units. If, for example, a process chamber with two sub-chambers is employed in which the same inert gas is used, the removed inert gas may be supplied to a common filter system for cleaning. In this case, a common duct/pipe through the partition wall and a common suction unit are also possible.

However, the use of separate sub-chambers for additive manufacturing of articles also allows the use of different inert gases in the individual sub-chambers. This enables a further increase in both the flexibility and the quality of the manufacturing process, as the respective inert gas may be selected according to the different requirements for manufacturing the different articles in the individual sub-chambers (e.g. in view of the required process parameters for manufacturing the different articles). In this case, the discharge of the different inert gases may take place via separate ducts/pipes in the partition wall by means of separate suction units to separate filter systems. In particular, the filter systems mentioned may be recirculating air filter systems which comprise the suction unit and supply the cleaned inert gas back to the at least one sub-chamber via the at least one gas inlet.

It is also possible that instead of the at least one gas outlet, the at least one gas inlet of the at least one sub-chamber providing the at least one working space is arranged/integrated in the at least one partition wall. In this case, the inert gas may be conducted, for example, from above through the partition wall and laterally from the latter into the sub-chamber(s). The at least one gas inlet may preferably be arranged in the partition wall in such a way that the inert gas supplied may flow uniformly over the build field of the at least one working space.

By integrating the gas inlet or the gas outlet in the partition wall, a larger area is available in the sub-chamber for the at least one working space, since no additional elements for supplying or discharging the inert gas have to be arranged in the sub-chamber. Consequently, the productivity of additive manufacturing can be increased as a larger number of articles can be manufactured in the sub-chamber.

Furthermore, by integrating the gas supply in the partition wall, the sub-chambers formed by the partition wall may be supplied with inert gas from central gas inlets, which may be arranged on both sides of the partition wall, for example. Alternatively, inert gas may be discharged from several sub-chambers by means of gas outlets on both sides of the partition wall. This enables a compact build-up of the inert gas supply for the individual sub-chambers of the process chamber, which can reduce flow losses and thus increase the efficiency of the manufacturing system.

According to an embodiment, the at least one gas inlet and the at least one gas outlet may be arranged opposite each other in the at least one sub-chamber. This means that either the at least one gas inlet or the at least one gas outlet may be arranged opposite the at least one partition wall. If the at least one gas outlet is arranged in the at least one partition wall, the gas inlet of the sub-chamber may be located in an element/component arranged in an outer area of the sub-chamber and facing the partition wall. In this case, a flow may be formed over the build field, flowing parallel thereto from an outer side to an inner side of the sub-chamber. In this way, a uniform velocity distribution may be achieved in the flow, whereby smoke and melt splashes may be continuously discharged. An inner side of a sub-chamber is to be understood as the side adjacent to the at least one partition wall and thus to an adjacent sub-chamber.

On the other hand, if the at least one gas inlet is arranged in the at least one partition wall, the gas outlet of the at least one sub-chamber may be located in an element/component arranged in an outer area of the sub-chamber. In this case, a flow may be formed over the build field, flowing parallel thereto from the inner side to the outer side of the sub-chamber. Preferably, the element in which the gas outlet is located is directly adjacent to the build field of the at least one working space, so that any smoke and melt splashes produced there may be extracted directly.

According to a further embodiment, the at least one powder coater for applying the powdery material to the build field may be arranged in the partition wall. For example, the powder supply of the at least one powder coater may be integrated directly into the partition wall, so that the material powder may reach the build field of the at least one working space of the at least one sub-chamber, e.g. via a duct/pipe in the partition wall. In this way, the working space in the sub-chamber can be made larger and thus the productivity of the manufacturing system can be additionally increased.

According to a further embodiment, the apparatus may further comprise a building container carrier disposed below the process chamber, the top side of which closes off the process chamber at the bottom. In other words, the top side of the building container carrier may comprise the bottom side/part of the bottom side of the process chamber. In order to seal the at least one gas inlet or outlet arranged in the partition wall against the top side of the building container carrier, the partition wall may have at least one seal on its bottom side.

The building container carrier may comprise at least one building container with a building plate and a lifting device which accommodates the at least one working space. This means that the at least one working space of the at least one sub-chamber may be arranged in the at least one building container. The building container carrier may comprise a plurality of building containers. In particular, each sub-chamber of the process chamber may include at least one building container. It is also possible for a sub-chamber to comprise a plurality of building containers.

The building plate of the at least one building container may in particular support the build field in the working space of the building container. This means that one or more articles to be manufactured may be built-up on the building plate. The lifting device may position the building plate vertically so that the at least one working space may be formed, for example, by lowering the building plate in the building container. In particular, the lifting device may move the building plate vertically downwards by a layer thickness (thickness of a layer of material powder to be applied) after each build-up step. A build-up step may comprise applying the material powder to the building plate by means of the at least one powder coater and solidifying the material by means of the at least one optical module.

According to a further embodiment, the building container carrier may move the at least one building container from a first position to a second position. Preferably, the building container carrier may be a cylindrical carrier that may be rotated to move the at least one building container from the first position to the second position. The rotation may preferably be about a longitudinal axis of the building container.

However, it is also possible that the building container carrier has a shape that differs from a cylinder and is designed, for example, as a cuboid, cube or truncated pyramid. To move the at least one building container, a translatory movement of the building container carrier may be carried out instead of/additionally to the rotation of the building container carrier in order to move the at least one building container from the first to the second position. In both the rotational and translational movement, the building container carrier itself moves to move the building container (self-movement). However, it is also possible that the building container carrier does not perform any movement of its own or that only parts of the building container carrier are moved. In this case, for example, the at least one building container may be moved from the first to the second position by means of a gripper.

A movement of the building container from a first and in a second position shall be understood as a movement of the building container from any position to another arbitrary position of the building container in the process chamber. The number of positions in the process chamber is not limited to two, but the building container may be moved to a plurality of positions. The term “from a first position to a second position” is only intended to express that the building container is moved from one position to a next position. It may thus also be moved from the second position to a third position, from the third position to a fourth position, etc. In a first position, the building container may, for example, be in a first sub-chamber, while in a second (next) position it may, for example, be in another sub-chamber of the process chamber. It is also possible that both positions are in one sub-chamber. Likewise, one of the positions may be below the at least one partition wall, for example in order to apply material powder from the powder coater arranged in the partition wall to the building plate of the at least one building container.

According to a further embodiment, the at least one building container may be rotatable about its longitudinal axis. Alternatively or additionally, the building plate of the at least one building container may be rotatable about its longitudinal axis and/or the longitudinal axis of the building container. In particular, the building container may have a cylindrical shape (building cylinder). However, it is also possible for the building container to have a shape that differs from a cylinder and to be designed, for example, as a cuboid or cube. Depending on the embodiment of the building container, the building plate may, for example, have a round or a rectangular shape. The building plate may be mounted on/in the building container such that its longitudinal axis coincides with the longitudinal axis of the building container. In this case, rotation about the longitudinal axis of the building plate simultaneously comprises rotation about the longitudinal axis of the building container. However, it is also possible that the longitudinal axes of the building plate and the building container do not coincide, and the building plate is arranged, for example, on a radius of a building cylinder at a distance from the longitudinal axis. In this case, a rotation of the building plate about the longitudinal axis of the building cylinder shall mean a movement of the building plate along this radius. A rotation of the building plate about its own longitudinal axis may in this case take place outside the longitudinal axis of the building cylinder, in a position at a distance from the latter about said radius. A rotation of the at least one building container or its building plate allows for different component orientations for different objects to be manufactured. This can additionally increase the flexibility and productivity of the manufacturing system. A component orientation is to be understood as the orientation/alignment of an article to be manufactured in the working space.

According to a further embodiment, the at least one powder coater for applying the powdery material to the build field may be integrated in the partition wall. In this case, the partition wall may preferably have at least one wiper lip on its bottom side. In this embodiment, the at least one powder coater may be fully included in the partition wall, and in particular, all functions of the powder coater may also be performed by means of the partition wall. As already described above, the powder coater may be supplied, for example, via a duct/pipe in the partition wall. In this case, the respectively required amount of material powder may be provided, e.g. by means of a conveyor shaft, and supplied to the building plate of the building container via the duct in the partition wall. The wiper lip located on the bottom side of the partition wall may distribute the material powder on the building plate when the building container passes the partition wall on its way from a first to a second position. This means that the powdery material is applied to the build field (coating) at the same time as the building container is moved. Before the building plate is moved under the partition wall with the wiper lip, it may be suitably positioned vertically by means of the lifting device, e.g. lowered by a layer thickness.

By means of this embodiment, the function of coating may be fully integrated into existing components of the apparatus, so that no separate powder coater component is necessary for supplying and distributing the material powder on the build field. This allows for an increased working space in each sub-chamber and additionally reduces the component effort for the manufacturing system.

According to a further embodiment, the building container carrier may also have at least one material discharge opening. Through this opening, excess material powder may be discharged from the at least one building container, in particular from its building plate. This may be done by an inherent movement, such as rotation, of the building container carrier, for example while it moves the at least one building container from a first to a second position. During such a movement, the surface of the building container carrier is continuously moved past/under the at least one wiper lip on the bottom side of the at least one partition wall, so that excess material on the surface may be continuously supplied to the at least one material discharge. This may preferably be arranged on the top side of the building container carrier. Most preferably, a plurality of material discharge openings may be arranged on the top side of the building container carrier. The excess material may be supplied to one or more powder overflow containers through the material discharge opening(s).

According to a further embodiment, at least one of the at least two sub-chambers may provide a space for preparing and finishing the layer-by-layer build-up of articles made of powdery material. In other words, at least one sub-chamber formed by means of the at least one partition wall may not be used as a working space for additive manufacturing of articles, but may serve, for example, as an unpacking and/or set-up station. In this case, no separate optical module is necessary in the sub-chamber in question. Such an embodiment allows to also integrate the pre-and post-processing of the articles to be manufactured/manufactured into the manufacturing system. In this way, the overall process can be optimised, and the productivity of the manufacturing can be additionally increased, since, for example, no distance has to be covered between a set-up station and the additive manufacturing system.

According to a further embodiment, a first one of the at least two sub-chambers may comprise a first powder coater. The first powder coater may apply a first powdery material to a first build field supported by a first building plate of a first building container that accommodates a first working space. Further, a second of the at least two sub-chambers may comprise a second powder coater. The second powder coater may in turn apply a second powdery material to a second build field supported by a second build plate of a second building container that accommodates a second working space. In particular, the second material may be different from the first material. However, it is also possible that the first and second materials are the same material. The exposure may be simultaneous in the working spaces.

According to a further embodiment, the first sub-chamber may have a first optical module that may spatially selectively irradiate the first powdery material provided in the area of the first build field. The second sub-chamber may accordingly have a second optical module which may spatially selectively irradiate the second powdery material provided in the area of the second build field. The number of sub-chambers is not limited to two, but a plurality of sub-chambers may be provided, on the build fields of which a different material may preferably be applied, which is subsequently irradiated by the optical module of the respective sub-chamber. In this way, articles made of different materials can be additively manufactured in different sub-chambers of a process chamber.

According to a further embodiment, the building container carrier may move the first building container with the first building plate from the first sub-chamber to the second sub-chamber, and move the second building container with the second building plate from the second sub-chamber to the first sub-chamber. This allows articles to be made from different materials. For example, the first building container with a powder layer of the first material applied to its building plate may be moved into the second sub-chamber after being irradiated by the first optical module. At the same time, the second building container with the second material may be moved into the first sub-chamber after irradiation. Then the two building plates may be positioned vertically, e.g. lowered by a layer thickness, and a powder layer of the second material may be applied to the first material in the second sub-chamber and a powder layer of the first material may be applied to the second material in the first sub-chamber. After irradiation by the first and second optical modules in the two sub-chambers, the two building containers may be moved again from one sub-chamber to the other and the process repeated. This enables, for example, the build-up of articles in sandwich construction.

The exact position of the first and second build field after a move from one sub-chamber to another may be detected by means of suitable sensors and transmitted to the first and second optical module. In this way, the focused laser beam of the two optical modules can always be positioned correctly. Additionally, the position of the first and second build field may be adjusted by rotating the first and second building container and/or their building plates as described above.

Preferably, the first and second powder coaters may be integrated in the at least one partition wall. The first powder coater may be mounted at a first position in/on the partition wall and the second powder coater may be mounted at a second position in/on the partition wall. At the bottom side of the partition wall, a first wiper lip may be arranged at the first position and a second wiper lip may be arranged at the second position. It is also possible that a continuous wiper lip is arranged on the bottom side of the partition wall. By means of the powder coaters integrated in the partition wall, the first and second material may be alternately applied to the first and second build fields. In particular, the first and second material may be alternately supplied to the first and second building plates and distributed on the building plates by moving the first and second building containers.

Excess material powder may be supplied to the at least one material discharge opening by its own movement, in particular the rotation of the building container carrier as described above by means of the wiper lip(s). If the first and second materials are different materials, the material powder mixed by the material discharge may be supplied to one or more powder overflow containers for reprocessing.

According to a further embodiment, the first sub-chamber and the second sub-chamber may have a common gas inlet or a common gas outlet. Preferably, the common gas inlet or outlet may be arranged/integrated in the at least one partition wall as described above. Thereby, the inert gas may be extracted from the first and second sub-chambers, which are preferably arranged on opposite sides of the partition wall, e.g. via openings in the two sides of the partition wall, into a common outlet duct in the partition wall. In a similar way, a common gas inlet into the first and second sub-chamber may be realised by conducting inert gas from above through a duct in the partition wall via openings in its side faces into the first and second sub-chamber.

Since in this case the same inert gas is used in both sub-chambers, a common filter system may be used with a common gas outlet through the partition wall. With a common gas inlet through the partition wall, only one inert gas supply is necessary. This enables a compact build-up of the inert gas supply for the two sub-chambers, which can reduce flow losses and thus increase the efficiency of the manufacturing system.

A method using the apparatus described above for layer-by-layer build-up of an article of powdery material by optical interaction comprises at least one of the steps described below.

In a first step, at least one working space is provided in at least one sub-chamber in the area of a build field, wherein the at least one sub-chamber is formed by dividing a process chamber by means of at least one partition wall. In particular, a plurality of sub-chambers may be formed by means of a plurality of partition walls. The working space may preferably be provided in a building container comprising a building plate and a lifting device.

In a second step, an inert gas is supplied to the at least one sub-chamber. In other words, an inert gas atmosphere is built-up in the at least one sub-chamber, which on the one hand can prevent the oxidation of the metallic material and on the other hand can help to discharge smoke and melt splashes from the build field.

When an inert gas atmosphere has been built-up in the at least one sub-chamber, in a third step powdery material is applied to the build field of the at least one working space in the at least one sub-chamber by means of at least one powder coater. The build field of the at least one working space may preferably be supported by the building plate of the building container. This may be positioned vertically by means of the lifting device. In particular, the building plate may be lowered by a layer thickness by the lifting device before the material powder is brought onto the build field by the at least one coater. As described above, the at least one powder coater may preferably be arranged in the at least one partition wall.

After the material powder has been applied to the build field, the powdery material provided in the area of the build field is spatially selectively irradiated by means of at least one optical module in a fourth step. In other words, the powdery material provided in the area of the build field of the sub-chamber is selectively irradiated by the at least one optical module according to geometry specifications for one or more articles to be manufactured. In particular, the optical module irradiates the powdered material selectively with a focused laser beam and heats it selectively to such an extent that it briefly changes completely into the liquid phase and solidifies during solidification.

After the material has been irradiated, the inert gas is discharged from the at least one sub-chamber in a fifth step in order to remove smoke and melt spatter from the build field. The removed inert gas is preferably supplied to a filter system for cleaning and then reintroduced into the sub-chamber via the at least one gas inlet. In particular, a continuous gas flow may be built-up over the build field, which ensures constant process conditions during the irradiation of the material powder. In other words, the second process step of the inert gas supply and the fifth process step of the inert gas discharge are not to be understood as one-off steps within the process sequence, but rather these steps take place continuously.

Steps two to five, i.e. the layer-by-layer application and solidification of the material powder onto the build field under a continuous flow of inert gas, are repeated until the article is completely built up/manufactured. In this process, either the inert gas is supplied to the at least one sub-chamber or the inert gas is discharged from the at least one sub-chamber by means of at least one gas inlet or at least one gas outlet arranged in the at least one partition wall. This enables a compact build-up of the inert gas supply for the at least one sub-chamber, whereby flow losses can be reduced. In addition, a larger area for the at least one working space is available in the at least one sub-chamber, since no additional elements for supplying or discharging the inert gas have to be arranged in the sub-chamber.

According to an embodiment, additionally at least one of the following steps may be performed between the second and third steps described above.

Before the powdery material is applied by means of the at least one coater, a first building plate may be positioned in the vertical direction in a first sub-chamber by means of a first lifting device. In particular, the first building plate may be lowered by a layer thickness by the first lifting device. The first building plate may be arranged in a first building container, which accommodates a first working space, for supporting a first build field. Similarly, a second building plate may be positioned vertically in a second sub-chamber by means of a second lifting device. In particular, the second building plate may also be lowered by a layer thickness by the second lifting device. The second building plate may be arranged in a second building container, which accommodates a second working space, for supporting a second build field.

After the vertical positioning of the first and second building plates, in a further step, the first and second building containers may be moved from a first position to a second position by means of a building container carrier in which the first and second building containers are arranged. In particular, the first and second building containers may be moved from a first position in the first and second sub-chambers to a second position below the partition wall. Preferably, a first and a second powder coater are arranged in the partition wall, which apply a first material powder to the first build field and a second material powder to the second build field. In particular, this may mean that the first and second material powder are supplied from a first and second duct in the partition wall to the first and second building plate and are distributed on the first and second building plate by means of at least one wiper lip arranged on a bottom side of the partition wall.

According to a further embodiment, the building container carrier may move the first and second building containers from the second position to a third position between the third and fourth steps, i.e. prior to spatially selectively irradiating the material powder. In particular, the first and second building containers may be moved from the second position below the two powder coaters in the partition wall to a third position in which the second building container is in the first sub-chamber and the first building container is in the second sub-chamber. In this third position, the first and second material powder may be spatially selectively irradiated by means of the at least one optical module in the respective sub-chamber and thereby solidified.

By repeating the steps described above, the first and second material powders may be applied alternately to the first and second build fields. In this way, articles made of two materials can be produced in sandwich construction in the present case. However, the number of sub-chambers, powder coaters and material powders is not limited to two, but there may be a plurality of sub-chambers, powder coaters and material powders, so that articles made of more than two materials may be manufactured.

### BRIEF DESCRIPTION OF THE FIGURES

FIG. 1a and 1b: schematically show an example of an apparatus for layer-by-layer build-up of articles made of powdery material by means of optical interaction in a spatial representation and in a cross-sectional representation;

FIGS. 2a and 2b: schematically show an interior view of the apparatus shown in FIG. 1a and 1b in a spatial representation;

FIGS. 3a and 3b: schematically show a further example of the apparatus for layer-by-layer build-up of articles made of powdery material by means of optical interaction in a spatial representation and in a cross-sectional representation;

FIGS. 4a to 4c: schematically show a top view and two sectional views of the apparatus shown in FIGS. 3a and 3b;

FIG. 5 schematically shows an example of a method for layer-by-layer build-up of articles made of powdery material by means of optical interaction;

FIGS. 6a and 6b: schematically show one more example of the apparatus for layer-by-layer build-up of articles made of powdery material by means of optical interaction in a spatial representation and in a plan view;

FIGS. 7a and 7b: schematically show a top view and a sectional view of the apparatus shown in FIGS. 6a and 6b.

### DETAILED DESCRIPTION OF PREFERRED EXAMPLES

In the following, examples of the present invention are described in detail with reference to exemplary figures. The features of the examples may be combined in whole or in part and the present invention is not limited to the described examples. In the figures, identical elements are provided with identical reference signs, so that a repeated description of the elements is omitted unless necessary.

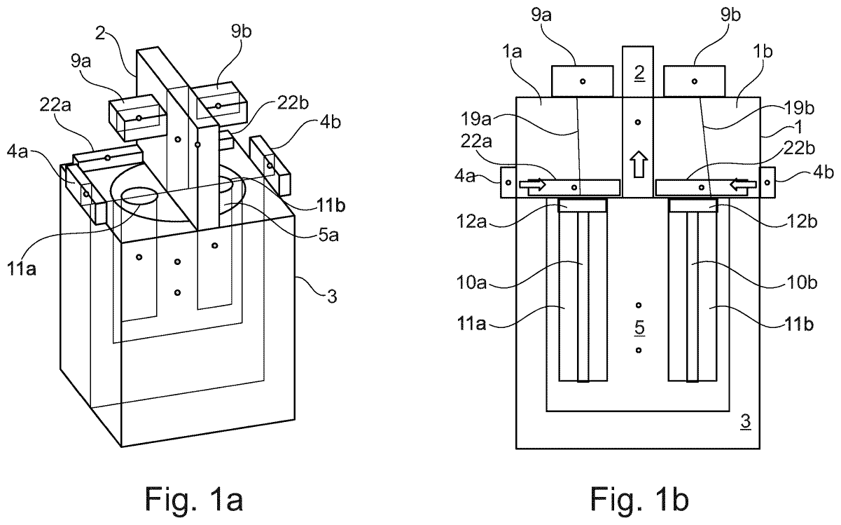

FIG. 1a and 1b schematically show an example of an apparatus for layer-by-layer build-up of articles made of powdery material by means of optical interaction in a spatial representation and in a cross-sectional representation. The sectional plane of the cross-sectional view in FIG. 1b is marked by thin dotted lines in FIG. 1a.

The apparatus shown comprises a process chamber 1 which is divided by a partition wall 2 into a first sub-chamber 1a and a second sub-chamber 1b. The process chamber 1 with its sub-chambers 1a, 1b is only shown in FIG. 1b for the sake of clarity. A powder coater 22a, 22b is arranged in each of the two sub-chambers 1a, 1b. Furthermore, an optical module 9a, 9b is mounted above each sub-chamber 1a, 1b and a gas inlet 4a, 4b is mounted on the outer sides of each sub-chamber 1a, 1b. The gas outlet of each sub-chamber 1a, 1b is located in the partition wall 2 (indicated by arrow in partition wall 2). The process chamber 1 is placed on a housing 3. Below the process chamber 1, a building container carrier 5 is mounted in the housing 3, which in the example shown includes a first building container 11a and a second building container 11b. Each of the two building containers 11a, 11b in turn comprises a lifting device 10a, 10b and a building plate 12a, 12b. In the example shown, the building container carrier 5 has a cylindrical shape and the building containers 11a, 11b are also designed as building cylinders. The top side 5a of the building container carrier closes off the process chamber 1 at the bottom and, in the example shown, forms part of the bottom side of the process chamber 1, respectively.

For the layer-by-layer build-up of one or more articles by means of selective laser melting, the powder coaters 22a, 22b each apply a layer of a powdery, preferably metallic material to a build field supported by the build plates 12a, 12b. Subsequently, the applied powder layer is spatially selectively irradiated by the optical modules 9a, 9b with a focused laser beam. In particular, the optical modules 9a, 9b selectively irradiate the powdery material provided on the building plates 12a, 12b with a focused laser beam 19a, 19b in each case, according to geometry specifications for the articles to be manufactured. After irradiation, the lifting devices 10a, 10b lower the building plates 12a, 12b by a layer thickness and the powder coaters 22a, 22b apply a further layer of material powder to the respective build field. The working space for the layer-by-layer build-up of the articles to be produced is formed in this way in the building containers 11a, 11b.

The division of the process chamber 1 into two sub-chambers 1a, 1b, each of which providing a working space for additive manufacturing, allows to produce different articles with different properties in one manufacturing system. Since both sub-chambers 1a, 1b each have their own powder coater 22a, 22b and their own optical module 9a, 9b, articles made of different materials, for example, can be produced in the individual sub-chambers 1a, 1b.

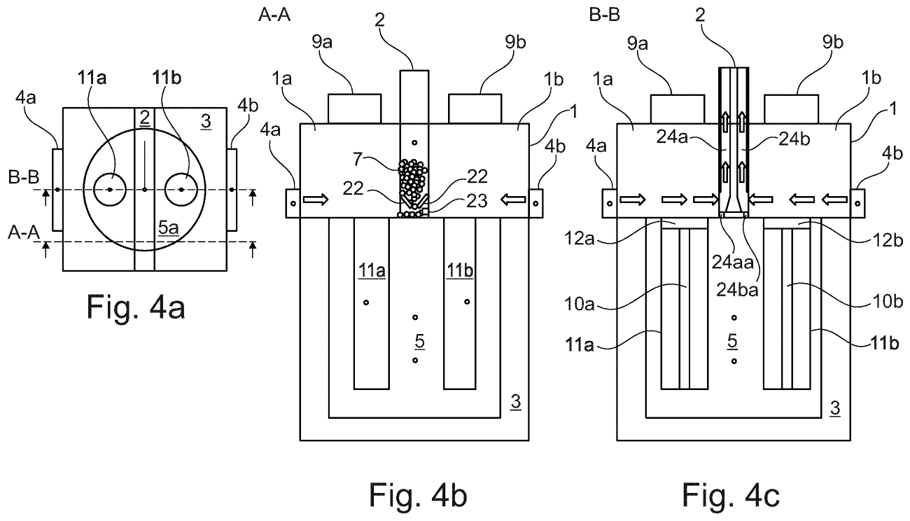

In order to prevent oxidation of the metallic material powder and to discharge smoke and melt splashes from the build field, an inert gas is introduced into the sub-chambers via the gas inlets 4a, 4b arranged at the sides of the sub-chambers 1a, 1b. This flows over the build field and is discharged centrally via gas outlets in the partition wall 2 (indicated by arrows in FIG. 1b). This builds-up a continuous gas flow. An example for the arrangement of the gas outlets is shown in FIG. 4c and is described in more detail in connection with this figure.

The arrangement of the gas inlets and outlets in the two sub-chambers 1a, 1b enables a homogeneous flow over the respective build field, which ensures constant process conditions. By dividing the process chamber 1 into two sub-chambers 1a, 1b, each of which having a separate inert gas flow, smoke and melt splashes may be reliably discharged.

Furthermore, the arrangement of the gas outlets in the partition wall 2 avoids additional components for gas discharge in the sub-chambers 1a, 1b, so that a larger working space is available for the additive manufacturing of the articles. If the same inert gas is used in both sub-chambers, it is possible to implement a common gas outlet in the partition wall 2, through which the contaminated inert gas may be supplied to a common filter system. In this way, the component effort of the manufacturing system can be reduced.

However, it is also possible to mount separate gas outlets in the partition wall 2, whereby different inert gases may be used in the two sub-chambers 1a, 1b. This additionally increases the flexibility and quality of the manufacturing process, as the respective inert gas may be selected according to the different requirements for manufacturing the different articles in the two sub-chambers.

Furthermore, only one of the two sub-chambers 1a, 1b may be used for additive manufacturing, while the other sub-chamber 1a, 1b may serve as an unpacking and set-up station. In this case, no separate optical module 9a, 9b is required in the sub-chamber in question 1a, 1b. Such an embodiment enables to also integrate the pre-and post-processing of the articles to be manufactured/manufactured into the manufacturing system. In this way, the overall process can be optimised, and the productivity of the manufacturing can be additionally increased, since, for example, no distance has to be covered between a set-up station and the additive manufacturing system.

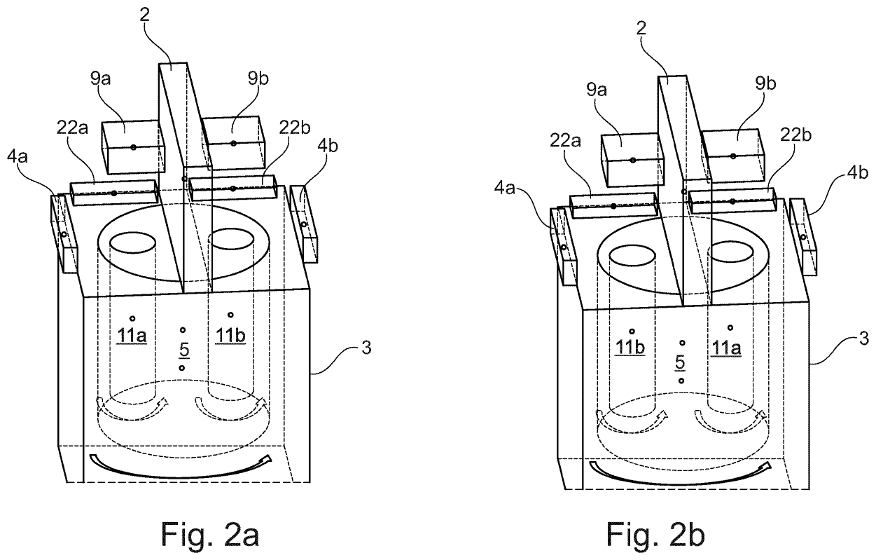

FIGS. 2a and 2b schematically show an interior view of the apparatus shown in FIGS. 1a and 1b in a spatial representation. In particular, FIGS. 2a and 2b show an example of the building container carrier 5 with the building containers 11a, 11b.

In FIG. 2a the building container 5 is shown in a position in which the building containers 11a, 11b are in a first position. The first building container 11a is in/below the first sub-chamber 1a and the second building container is in/below the second sub-chamber 1b (cf. FIG. 1b). By rotating the building container carrier 5 around its longitudinal axis, the two building containers 11a, 11b in FIG. 2b are in a second position, in which the first building container 11a is positioned in/below the second sub-chamber 1b and the second building container is positioned in/below the first sub-chamber 1a. The rotation of the building container 5 is indicated by the arrow shown below the building container 5. The arrows shown below the building containers 11a, 11b illustrate that in the present example, the individual building containers 11a, 11b may also be rotated around their longitudinal axis.

By moving the two building containers 11a, 11b from one sub-chamber 1a, 1b to another sub-chamber 1a, 1b, both having a separate powder coater 22a, 22b and a separate optical module 9a, 9b, articles may be made from two different materials. For example, after applying and solidifying a layer of powder with both building containers 11a, 11b in the first position, the building container carrier 5 may be rotated so that the building containers 11a, 11b are then in the second position. While in the first position, in which the first building container 11a was in the first sub-chamber 1a, a first material was applied to a first build field of the first building container 11a and solidified, a second material may now be applied to the first build field of the first building container 11a in the second sub-chamber 1b and solidified. The same applies in reverse for a second build field of the second building container 11b. Subsequently, the building container carrier 5 may be rotated again so that both building containers 11a, 11b are in the first position again and a new layer of the initial material may be applied and solidified on the first and second build field. In this way, articles can be made from two materials in sandwich construction.

The exact position of the first and second build field of the building containers 11a, 11b in the sub-chambers 1a, 1b after a rotation of the building container carrier 5 may be detected by means of suitable sensors and transmitted to the optical modules 9a, 9b. In this way, the focused laser beam of the two optical modules 9a, 9b can always be positioned correctly. Additionally, the position of the first and second build field may be adjusted by rotating the first and second building container. In the example shown, the building containers 11a, 11b rotate around their longitudinal axis so that different component orientations may be realised in the two building containers 11a, 11b. However, it is also possible that instead of the building containers or in addition to the building containers, the building plates 12a, 12b may be rotated. These may be mounted centrally in the building container 11a, 11b, so that the respective building plate 12a, 12b has the same longitudinal axis as the building container 11a, 11b. However, it is also possible for the building plates 12a, 12b to be mounted at a distance from the longitudinal axis of the building container 11a, 11b. In this case, the building plates 12a, 12b may preferably be rotated around their own longitudinal axis as well as around the longitudinal axis of the building container 11a, 11b. This results in a high degree of freedom in view of the positioning of the articles to be manufactured in the working space.

It is also possible that the apparatus shown comprises more than one partition wall 2. For example, the process chamber 1 may be divided into four sub-chambers 1a, 1b by means of two partition walls 2 arranged e.g. perpendicular to each other. In this case, if each of these sub-chambers 1a, 1b has its own powder coater 22a, 22b and its own optical module 9a, 9b, articles may be manufactured from up to four materials. Depending on the size of the process chamber 1, more than two partition walls 2 may also be mounted in the process chamber 1 to divide the process chamber 1 into more than four sub-chambers 1a, 1b.

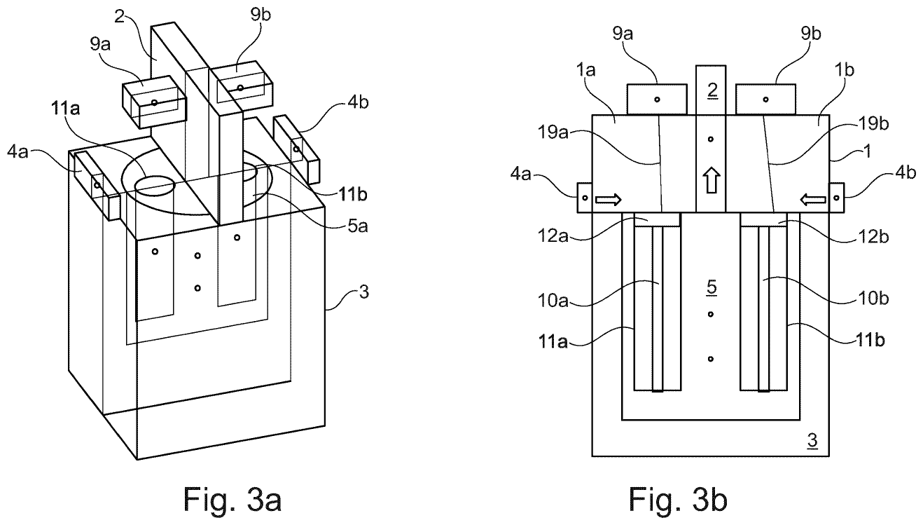

FIGS. 3a and 3b schematically show a further example of the apparatus for layer-by-layer build-up of articles made of powdery material by means of optical interaction in a spatial representation and in a cross-sectional representation. The sectional plane of the cross-sectional view in FIG. 3b is marked by thin dotted lines in FIG. 3a. The process chamber 1 with its sub-chambers 1a, 1b is again only shown in FIG. 3b for the sake of clarity. The example shown here differs from the previous one only in that the powder coaters 22a, 22b are no longer provided in the first and second sub-chambers 1a, 1b. All other elements are identical in construction to the apparatus shown in FIGS. 1a and 1b. In the present example, the two powder coaters 22a, 22b are integrated in the partition wall 2. A realisation of this integration is described in more detail below in connection with FIG. 4b.

FIGS. 4a to 4c schematically show a top view and two sectional views of the apparatus shown in FIGS. 3a and 3b. FIG. 4a essentially serves to define the sectional planes A-A and B-B through the apparatus, which are shown in FIGS. 4b and 4c.

FIG. 4b shows an example of an integration of a single powder coater 22 in the partition wall 2, which is arranged in the sectional plane A-A. A second powder coater may be integrated in the partition wall 2 in the same way, e.g. on a side of the apparatus opposite the sectional plane A-A (e.g. in a plane resulting from a reflection of the sectional plane A-A at the centre line B-B). In particular, these two powder coaters 22 integrated in the partition wall 2 may be used to manufacture articles made of two materials in sandwich construction in the same way as described in the previous example. It is also possible for the apparatus to have more than one partition wall 2. For example, the process chamber 1 may be divided into four sub-chambers 1a, 1b by means of two partition walls 2, whereby two powder coaters 22 may be integrated in each partition wall 2. Thus, the present example of the apparatus also allows for producing articles made from more than two materials.

It can be seen that a quantity of material powder 7 is supplied to the powder coater 22 from above through the partition wall 2. The layer-by-layer required amount of material powder 7 may be provided, for example, via a conveyor shaft in the partition wall 2. This then reaches the top side 5a of the building container carrier 5 via a funnel-shaped opening on the side of the coater 22 facing the building container carrier 5. By means of a wiper lip 23 arranged on the bottom side of the partition wall 2, the material powder 7 may be applied to the build field of the first building container 11a by rotating the building container carrier 5. In particular, the required amount of material powder 7 may reach the build field of the first building container 11a directly via the funnel-shaped opening of the coater 22, so that a distribution of the material powder 7 on the build field may take place by means of the wiper lip 23 by rotation of the building container carrier 5. For this purpose, the building container 11a may be rotated in advance to a suitable position with respect to the powder coater 22. Before the material powder 7 is applied to the build field of the first building container 11a, its build plate 12a may preferably be lowered by a layer thickness.

FIG. 4c shows an example of the integration of two gas outlets 24a, 24b in the partition wall 2, through which the inert gas may be removed from the first and second sub-chambers 1a, 1b. The inert gas is discharged from the first sub-chamber 1a via a first gas outlet 24a and the inert gas from the second sub-chamber 1b via a second gas outlet 24b. To seal the gas outlets 24a, 24b against the top side 5a of the building container carrier 5, seals 24aa, 24ba are attached to the bottom side of the partition wall 2 in the area of the gas outlets. The inert gas contaminated by smoke and melt splashes, which is discharged from the two sub-chambers 1a, 1b through the gas outlets 24a, 24b, may be supplied to a filter system (not shown). Preferably, this may be a recirculating filter system in which the inert gas is purified and then fed back into the sub-chambers 1a, 1b via the gas inlets 4a, 4b. If the same inert gas is used in both sub-chambers 1a, 1b, it may be supplied to a common filter system for cleaning. In this case, a common gas outlet 24a, 24b through the partition wall 2 is also possible.

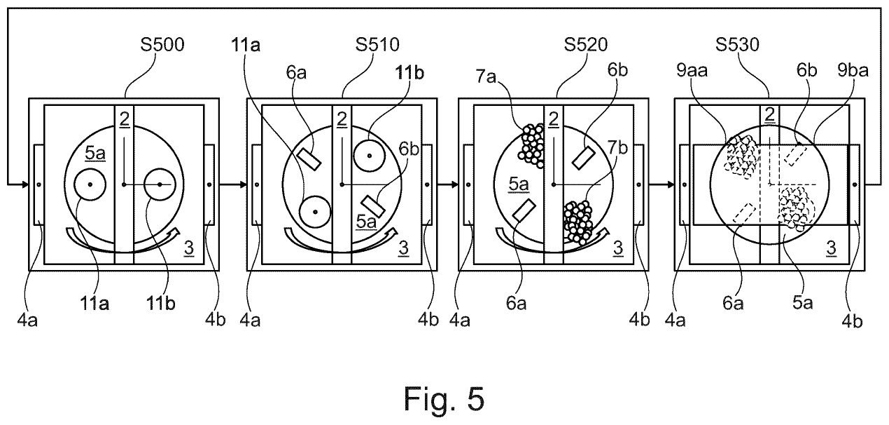

FIG. 5 schematically shows an example of a method for layer-by-layer build-up of articles made of powdery material by means of optical interaction.

In a step S500, a first sub-chamber 1a and a second sub-chamber 1b are first formed by dividing a process chamber 1 by means of a partition wall 2, and a working space in the area of a build field is provided in each of the two sub-chambers 1a, 1b. For this purpose, each of the two sub-chambers 1a, 1b comprises a building container 11a, 11b, which in turn has a building plate 12a, 12b and a lifting device 10a, 10b (see e.g. FIGS. 1b, 3b and 4c). The working space in the two sub-chambers is provided by vertically positioning the building plates 12a, 12b in the building containers 11a, 11b by means of the lifting devices 10a, 10b, in particular by lowering them by a layer thickness (thickness of a layer of material powder to be applied). Furthermore, an inert gas atmosphere/inert gas flow is built-up in both sub-chambers 1a, 1b in order to prevent oxidation of the material powder to be applied and to remove smoke and melt splashes from the build field. Thereby, the gas supply to the first sub-chamber 1a is provided via a first gas inlet 4a and the gas supply to the second sub-chamber 1b is provided via a second gas inlet 4b. The gas outlet of the two sub-chambers 1a, 1b is provided via the partition wall (see FIG. 4c).

After vertically positioning the first and second building plates 12a, 12b, in a next step S510, the first and second building containers 11a, 11b are moved from a first position to a second position by means of a building container carrier 5 in which the first and second building containers are arranged. In the present case, the first and second building containers 11a, 11b are moved from a first position in the first and second sub-chambers 1a, 1b to a second position under the partition wall 2 or adjacent to the partition wall 2. A first and a second powder coater are arranged in the partition wall 2 (see FIG. 4b), which apply a first material powder 7a to the first build field and a second material powder 7b to the second build field. In particular, this may mean that the first and second material powder 7a, 7b are supplied from a first and second duct in the partition wall 2 to the first and second building plate 12a, 12b and distributed on the first and second building plate 12a, 12b by means of at least one wiper lip 23 arranged on a bottom side of the partition wall 2 (see also FIG. 4b).

After applying the first and second material powders 7a, 7b to the first and second build fields, the building containers 11a, 11b are moved from the second position to a third position by means of the building container carrier 5 in a next step S520.

In the present example, the first and second building containers 11a, 11b are moved from the second position below the two coaters in the partition wall 2 to a third position in which the second building container 11b is located in the first sub-chamber 1a and the first building container 11b is located in the second sub-chamber 1b. In the third position, the two building containers 11a, 11b are also each located in an irradiation area 9aa, 9ba of a first and second optical module 9a, 9b and, at the same time, in an optimal area of the inert gas flow between the gas inlet 4a, 4b and the gas outlet of the respective sub-chamber. Therefore, in this position, in a next step S530, the first and second material powder may be spatially selectively irradiated by means of the optical modules 9a, 9b and thereby solidified.

During rotation from the second to the third position, excess material powder 7a, 7b, which may be on the top side 5a of the building container carrier 5a, may be conveyed/pushed by means of the wiper lip 23 via the material discharge openings 6a, 6b into one or more powder overflow containers (not shown).

By repeating the steps S500 to S530 described above, the first and second material powder 7a, 7b may be applied alternately to the first and second build fields. In this way, according to the described example, articles may be produced from two materials in sandwich construction. Thereby, the building container carrier 5 may rotate continuously, i.e. both the application and the irradiation of the first and second material powders 7a, 7b may already take place during the rotation of the building container carrier 5. Likewise, excess material powder 7a, 7b may be continuously removed from the surface 5a of the building container carrier during rotation, as it is constantly moved under the wiper lip 23. The continuous process of material application and solidification can significantly accelerate the production of additively manufactured articles and thus increase the productivity of the manufacturing system.

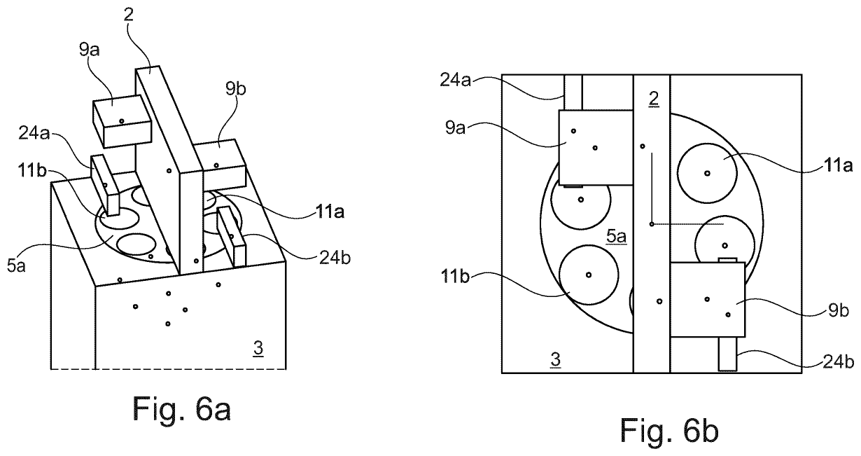

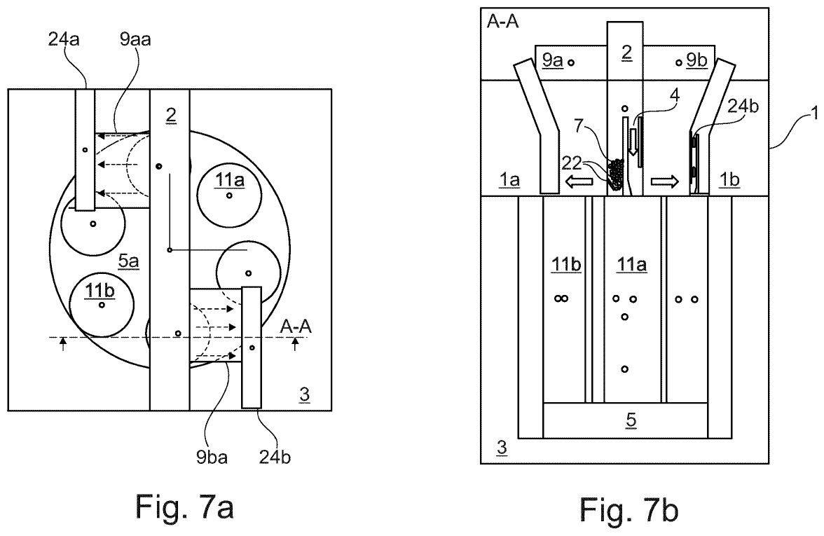

FIGS. 6a and 6b schematically show one more example of the apparatus for layer-by-layer build-up of articles of powdery material by means of optical interaction in a spatial representation and in a plan view. The example shown here differs from the previous one in that on the outer sides of the first and second sub-chambers 1a, 1b, a first and second gas outlet 24a, 24b are arranged instead of the first and second gas inlets 4a, 4b. Moreover, in this example, the building container carrier 5 comprises six building containers 11a, 11b instead of only two. For this reason, the two optical modules 9a, 9b are not arranged directly opposite each other on both sides of the partition wall 2, as shown in the previous examples, e.g. in FIGS. 1a and 3a, but are mounted spaced apart from each other in the direction in which the partition wall extends (cf. FIG. 6b). The same applies to the first and second gas outlets 24a, 24b, which, in contrast to the gas inlets 4a, 4b shown in FIGS. 1a and 3a, are likewise not arranged opposite each other but mounted spaced apart from each other in the direction in which the partition wall 2 extends. In particular, the gas outlets 24a, 24b in this example are arranged in such a way that smoke and melt splashes (also referred to as process by-products) may be extracted directly where they occur. The gas is supplied to the two sub-chambers 1a, 1b via corresponding gas inlets in the partition wall 2. This is explained in more detail below in connection with FIGS. 7a and 7b.

FIGS. 7a and 7b schematically show a top view and a sectional view of the apparatus shown in FIGS. 6a and 6b.

FIG. 7a shows a top view of the irradiation areas 9aa, 9ba of the two optical modules 9a, 9b shown in FIGS. 6a and 6b. Due to the opposing gas inlets and outlets in the two sub-chambers 1a, 1b, a inert gas flow is provided in each of the irradiation areas 9aa, 9ba. The inert gas flows from gas inlets arranged in the partition wall in the direction of the gas outlets 24a, 24b. This is indicated by thin arrows in the irradiation areas 9aa, 9ba.

It is clear that the irradiation areas 9aa, 9ba with the associated inert gas flow are arranged in such a way that the build fields of the six building containers 11a, 11b present in this example may be irradiated continuously one after the other by means of rotation of the building container carrier 5. In particular, with continuous rotation of the building container carrier 5, a process step of the additive manufacturing (application of the material powder, irradiation of the material powder, lowering of the building plates) can always take place on each build field of the six build containers 11a, 11b.

FIG. 7b shows the apparatus shown in FIGS. 6a and 6b in the sectional plane A-A. The sectional plane A-A is defined in FIG. 7a and corresponds to the sectional plane A-A according to FIGS. 4a and 4b. In the present example, the gas inlet 4 is integrated into the partition wall 2 in addition to the powder coater 22. The gas is supplied from above through the partition wall 2 and is subsequently introduced laterally into the second sub-chamber 1b. The gas inlet is arranged directly opposite the gas outlet 24b so that a uniform inert gas flow may form over the build field of a building container 11a, 11b entering the irradiation area 9ba. The gas inflow into the sub-chamber 1b, the gas flow over the build field and the gas discharge through the gas outlet 24b are marked with corresponding arrows in FIG. 7b.

Analogously to the example shown in FIG. 4b, a further powder coater may be integrated in the same way, e.g. on a side of the apparatus opposite the sectional plane A-A, and a further gas inlet may be integrated in the same way, e.g. on a side of the apparatus opposite the sectional plane A-A, in the partition wall 2. The further gas inlet may in particular be arranged directly opposite the gas outlet 24a in order to form a uniform inert gas flow over the build field of a building container 11a, 11b entering the irradiation area 9aa. If two different inert gases are used in the first and second sub-chamber 1a, 1b, they are supplied to different filter systems (not shown) for purification.

In the present example, if the same inert gas is used in both sub-chambers 1a, 1b, this may also be conducted downwards via a common down pipe in the partition wall 2 and conducted by means of branches to the gas inlets at the irradiation areas 9aa, 9ba. In this case, the contaminated inert gas may be conducted through the two gas outlets 24a, 24b to a common filter system.

Since, in this example, two powder coaters 22 may also be integrated in the partition wall 2, it is also possible in this case to manufacture articles from two materials in a sandwich construction. Likewise, more than one partition wall 2 with integrated powder coaters 22 and gas inlets 4 may be fitted in the process chamber 1, so that the present example of the apparatus also enables a manufacturing of articles made of more than two materials.

1. Apparatus for a layer-by-layer build-up of articles of powdery material by means of optical interaction, in particular by the method of selective laser melting, comprising:
a process chamber for providing at least one working space in the area of a build field;
at least one partition wall which divides the process chamber into at least two sub-chambers, one of the at least two sub-chambers providing the working space;
a powder coater for applying the powdery material to the build field;
an optical module of an irradiation unit for spatially selective irradiation of the powdery material provided in the area of the build field;
a gas inlet for supplying an inert gas to the sub-chamber; and
a gas outlet for discharging the inert gas from the sub-chamber; wherein
the gas inlet and/or the gas outlet is arranged in the at least one partition wall.

2. Apparatus according to claim 1, wherein.
the gas inlet and the gas outlet are arranged opposite each other in the at least one sub-chamber.

3. Apparatus according to claim 1, wherein
the at least one powder coater for applying the powdery material to the build field is arranged in the partition wall.

4. Apparatus according to claim 1, further comprising:
a building container carrier, which is arranged below the process chamber and whose top side closes off the process chamber at the bottom, the building container carrier having at least one building container with a building plate and a lifting device, which accommodates the working space, wherein
the lifting device is configured to vertically position the building plate in one of the at least two sub-chambers, and the building plate is configured to support the build field.

5. Apparatus according to claim 4, wherein
the building container carrier is configured to move the at least one building container from a first position to a second position.

6. Apparatus according to claim 4, wherein.
the at least one building container is rotatable about its longitudinal axis, and/or
the building plate of the at least one building container is rotatable about its longitudinal axis and/or about the longitudinal axis of the building container.

7. Apparatus according to claim 1, wherein
the powder coater for applying the powdery material to the build field is integrated in the partition wall, and/or the partition wall has at least one wiper lip (23) on its bottom side.

8. Apparatus according claim 4, wherein
the building container carrier has at least one material discharge opening.

9. Apparatus according to claim 1, wherein
at least one of the at least two sub-chambers is configured to provide a space for pre- and post-processing the layer-by-layer build-up of articles made from powdery material.

10. Apparatus according to claim 1, wherein
a first of the at least two sub-chambers comprises a first powder coater configured to apply a first powdery material to a first build field supported by a first building plate of a first building container accommodating a first working space; and
a second of the at least two sub-chambers comprises a second powder coater configured to apply a second powdery material to a second build field supported by a second building plate of a second building container accommodating a second working space.

11. Apparatus according to claim 10, wherein.
a first optical module is assigned to the first sub-chamber and is configured to spatially selectively irradiate the first powdery material provided in the area of the first build field, and
a second optical module is assigned to the second sub-chamber and is configured to spatially selectively irradiate the second powdery material provided in the area of the second build field.

12. Apparatus according to claim 10, wherein
the building container carrier is configured to move the first building container with the first building plate from the first sub-chamber into the second sub-chamber, and to move the second building container with the second building plate from the second sub-chamber into the first sub-chamber.

13. Apparatus according to claim 10, wherein
the first sub-chamber and the second sub-chamber comprise a common gas inlet and/or a common gas outlet.

14. Method for layer-by-layer build-up of an article of powdery material by means of optical interaction using an apparatus according to at least one of the preceding claims comprising at least one of the steps:
(1) providing a working space in at least one sub-chamber in an area of a build field, the at least one sub-chamber being formed by dividing a process chamber by means of at least one partition wall;
(2) supplying an inert gas to the at least one sub-chamber,
(3) applying powdery material to the build field of the working space of the at least one sub-chamber by means of at least one powder coater,
(4) spatially selectively irradiating the powdery material provided in the area of the at least one build field by means of at least one optical module; and
(5) discharging the inert gas from the at least one sub-chamber,
(6) repeating the above steps (2) to (5) until the build-up of the article is complete,
wherein the inert gas is supplied into the at least one sub-chamber and/or
the inert gas is discharged from the at least one sub-chamber by means of at least one gas inlet or at least one gas outlet arranged in the at least one partition wall.

15. Method according to claim 14, wherein additionally at least one of the following steps is carried out:
vertically positioning a first building plate for supporting a first building field in a first building container accommodating a first working space by means of a first lifting device in a first sub-chamber, and vertically positioning a second building plate (12b) for supporting a second building field in a second building container accommodating a second working space by means of a second lifting device in a second sub-chamber; and
moving the first and second building containers from a first position to a second position by means of a building container carrier in which the first and second building containers are arranged.

16. Method according to claim 15, wherein additionally the following step is carried out:
moving the first and second building containers from the second position to a third position by means of the building container carrier.
